(19) United States
(12) Patent Application Publication
(10) Pub. No.: US 2005/0077828 A1
(43) Pub. Date: Apr. 14, 2005

(54) Discharge lamp

(76) Inventor: Michael Haacke, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/500,503

(22) PCT Filed: Dec. 12, 2002
(86) PCT No.: PCT/IB02/05290

(30) Foreign Application Priority Data
Jan. 2, 2002 (DE) 102 00 009.3

(51) Int. Cl. H01J 17/18; H01J 17/04; H01J 1/62

(52) U.S. Cl. 313/631; 313/624; 313/623; 313/491

(57) ABSTRACT

A discharge lamp (10) is disclosed with a closed discharge vessel (20) which is surrounded by a wall of transparent material. Two electrodes (30) are present, partly embedded in the wall and projecting into the interior of the discharge vessel (20). At least one, but preferably both electrodes (13) are elongate in shape and comprise a head part (50) and a shaft part (40), which are distinguished by different diameters and/or different materials. Tungsten is preferred for the head part (50) and a tungsten-rhenium alloy for the shaft part (40). The shaft part (40) is enclosed in the wall material, usually quartz, whereas of the head part (50) only a first, short portion (50a) is in contact with the wall, while its second, longer portion (50b) projects into the interior of the discharge vessel (20). Favorable diameters for the head part (50) were found to be 350 to 450 μm, and for the shaft part (40) 150 to 400 μm. A long lamp life is achieved with the electrode design according to the invention, in particular in thermally strongly loaded discharge lamps as preferred for automotive applications. There are additional advantages in a lesser crystallization of the discharge vessel (20), less burning-off of the electrodes (30), and an improved run-up behavior.

The invention relates to a discharge lamp.

Gas discharge lamps, in which light is generated by means of a gas discharge between two electrodes, have long been known.

EP-A-0 570 068 discloses a high-pressure gas discharge lamp in which a burner is supported in a lamp cap. The burner comprises a discharge vessel which is closed in a gastight manner and which has two electrodes. The discharge vessel has a wall which forms neck regions at its respective ends. Electrodes electrically connected to external contacts are arranged in the respective neck regions, projecting into the interior of the discharge vessel. The interior of the discharge vessel is filled with an ionizable filling of mercury, rare gas, and metal halide, for example sodium iodide and xenon.

WO-A-92/12530 discloses a discharge lamp for low powers, i.e. below 40 watts. The lamp comprises a discharge vessel formed by a wall of quartz glass, into which two electrodes project into the interior. The electrodes each have a head region of substantially cylindrical shape which is fully inside the interior of the discharge vessel and has no contact to the vessel wall. A shaft region of small diameter merges into said head region of the electrode, which shaft region is embedded in the material of the wall in a neck region of the wall. The head and shaft parts of the electrode are made of tungsten, the diameter of the head part being 280 to 355 μm and the diameter of the shaft part being small, i.e. 76 μm in this case. The head and shaft parts are welded together. It is noted that a head part of large diameter renders possible a satisfactory distribution of heat arising during the discharge, so that the electrodes are not burnt off. The transition to a shaft part of small diameter ensures that the heat transfer from the head is reduced.

WO-A-98/37571 discloses a high-pressure metal halide lamp. This comprises a closed discharge vessel of light-transmitting material which merges into neck regions at two mutually opposed ends. Elongate electrodes are arranged in the neck regions, each electrode consisting of a head part of tungsten and a shaft part of a tungsten-rhenium alloy with at least 25% by weight of rhenium. The transition from the tungsten head part to the tungsten-rhenium shaft part takes place in a location which has an operating temperature of 1900 to 2300 K. It is noted that at least 25% by weight of rhenium is necessary for preventing fracture of the electrode after the tungsten portion has become removed owing to reaction with the halogen gas filling. It is stated here that a cyclical process establishes itself, in which process tungsten evaporates from the electrodes and is transported back to the electrodes again by halides. The construction of the head part of tungsten here prevents an excessive evaporation.

The head and shaft parts are welded together in the electrode disclosed. The head part may have a winding of tungsten wire around it. The diameter of the head part is again 0.8 mm, and the diameter of the shaft part is 0.8 mm. The shaft part is embedded with its rear end into the material of the wall, where it is electrically connected to a molybdenum foil provided for sealing.

It was found in known discharge lamps with electrodes of conventional construction and shape that a considerable reduction of product life can be observed in particular in the case of high thermal loads.

It is accordingly an object of the invention to provide a discharge lamp which has a long useful life also when heavily loaded.

This object is achieved by means of a discharge lamp as defined in claim 1. The dependent claims relate to advantageous embodiments of the invention.

According to the invention, the electrode consists of a head part and a shaft part. These may be made of different materials. Alternatively or additionally, the head and shaft parts may also have different diameters. The shaft part will then have no free surface exposed to the interior of the discharge vessel here. It is enclosed in the material forming the wall, for example quartz glass, over its full length. The head part is also in contact with the wall by a first portion, but projects into the discharge vessel with a second, longer portion.

The invention is explained here by way of example merely with reference to one electrode. It should be obvious that usually two electrodes are present, which are preferably of the same construction.

The invention is based on considerations aimed at optimizing the useful life of discharge lamps also under high thermal loads. Such loads occur, for example, with the use of mercury-free fillings, or with the use of lamps of high power and small dimensions, for example 60 W discharge lamps for automobiles. The considerations in addition relate to as small as possible a decrease in the luminous flux over lamp life (lumen maintenance) and the so-termed run-up behavior of the lamp. It is advantageous here for a high luminous flux to be reached as quickly as possible.

The requirements to be imposed on the electrode head are different from the requirements to be imposed on the electrode shaft. The electrode shaft is embedded in the wall of the discharge vessel. Quartz glass is mostly used for this. It was found that product life is dependent inter alia on the adhesion between the wall material [and the shaft].

Another factor influencing product life is burning-off of the electrodes. This takes place at the electrode head. The requirement set for the electrode head is accordingly that of as high as possible a resistance to burning-off.

The head part of the electrode comprises a first, shorter portion which is embedded in the material of the wall. According to the invention, the second portion, which projects into the discharge vessel, is longer than the first portion. It is preferred here that the length of the first portion is less than 25% of the total length of the head part, preferably even less. Since only a short portion of the head part is embedded in the wall, an excessive heat transfer to the wall material and an accompanying strong thermal loading are avoided. On the other hand, however, the embedding of the head part in the wall leads to a clear improvement in mechanical stability. This is advantageous especially in the automotive field in view of the mechanical loads to be expected there. Embedding of a portion of the head part in the wall in addition achieves an improved heat transition from the electrode to the wall material, which provides a good, i.e. faster run-up behavior.

The length of the first portion, i.e. the length over which the head part is embedded in the wall, will always be a compromise between the requirements mentioned above. The lower limit for the length of this region is set by the desired result as regards the run-up behavior and mechanical stability. The upper limit is given by the thermal load on the wall material during continuous operation. The actual limits are dependent on a plurality of factors within a certain application. Experiments with lamps used in the automotive field have shown that a value of up to approximately 0.7 mm is useful for the length of the first portion. Preferably, the embedded length is approximately 0.05 to 0.5 mm. In a concrete application with strongly differing requirements or parameters, however, different dimensions may indeed be chosen.

The electrode preferably has a substantially circular cross-section. The head and shaft parts of the electrode may be made from the same material in the case of different diameters. The electrode may then be manufactured in one piece, the portions of different diameter being formed, for example, by grinding or etching.

A welded joint is preferred for the connection between the head part and the shaft part of the electrode if the electrode is formed by a head and shaft part of different materials. It was found to be favorable for the strength of this joint if the diameter of the head part corresponds substantially to the diameter of the shaft part. Preferably, the diameters should not differ by more than 30% from one another. Diameters of 350 to 450 μm are proposed for the head part, and diameters of 150 to 400 μm for the shaft part. The preferred diameter of the shaft part lies between 250 and 400 μm. Alternative diameters are possible, however, to comply with special requirements.

The head part and the shaft part of the electrode are preferably made of different materials. It is proposed that the head part consists of tungsten for at least 90% by weight. Pure tungsten is preferably used as the material for the head part. This material has a good stability against burning-off of the electrode because of its high melting point.

If there is a very good adhesion between the material of the electrode portion embedded in the wall and the quartz glass, a stress relief crack will arise upon heating because of the difference in coefficient of thermal expansion, which crack is denoted “pearl crack”. This behavior is particularly advantageous for product life, because it counteracts the formation of radial glass cracks which could propagate to the exterior. An effect similar to a pearl crack arises in the case of a tungsten-rhenium alloy which has a good adhesion to quartz glass.

In a further embodiment, it is provided that the shaft part consists of 60 to 85% by weight of tungsten, and the remainder rhenium. The alloys disclosed here should be understood such that those components are indicated which are dominant in determining the respective properties. Further elements may be present in small concentrations of, for example, less than 1%, without this being separately noted. A tungsten-rhenium alloy with 74% by weight of tungsten and 26% by weight of rhenium is preferred. The electrode shaft formed from the tungsten-rhenium alloy has a lower thermal conductivity than the head part of tungsten. A diameter of the shaft part of 250 to 400 μm, preferably even 300 to 400 μm, is accordingly useful here for heating up the quartz quickly enough during switching-on of the lamp in spite of the low thermal conductivity. Given these diameters, a sufficient heat removal from the electrode tip is also obtained, so that the head part is thermally relieved during continuous operation.

The use of thoriated tungsten, for example VMT10, with 1% by weight of thorium oxide was common in known lamps. It is proposed in a further embodiment that the electrode material is free from thorium. It was found in experiments that the suspected strong influence of thorium oxide on the ignition behavior is not as strong as was assumed. It is additionally proposed that the gas filling is free from thorium. The omission of thorium leads to better environmental properties of the lamp. Most importantly, however, it was found that thorium oxide acts as a crystallization nucleus for the wall material of the discharge vessel. The omission of thorium considerably reduces the luminous decrement over lamp life, i.e. improves the lumen maintenance.

The geometry of the electrodes may differ considerably over various applications. In a further embodiment of the invention it is preferred that the length of the head part is approximately 15 to 50% of the total length of the electrode. The length of the head part is preferably approximately 1 to 3 mm in typical applications, in particular in automobiles, and the length of the shaft part is approximately 3 to 7 mm.

Embodiments of the invention will be explained in more detail below with reference to drawings, in which:

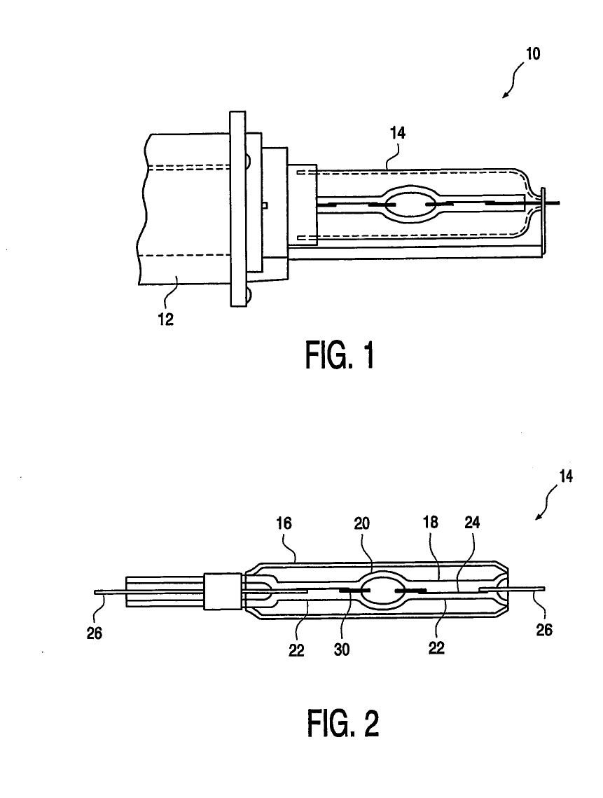

FIG. 1 is a side elevation of a first embodiment of a discharge lamp;

FIG. 2 is a side elevation of the burner of the discharge lamp of FIG. 1;

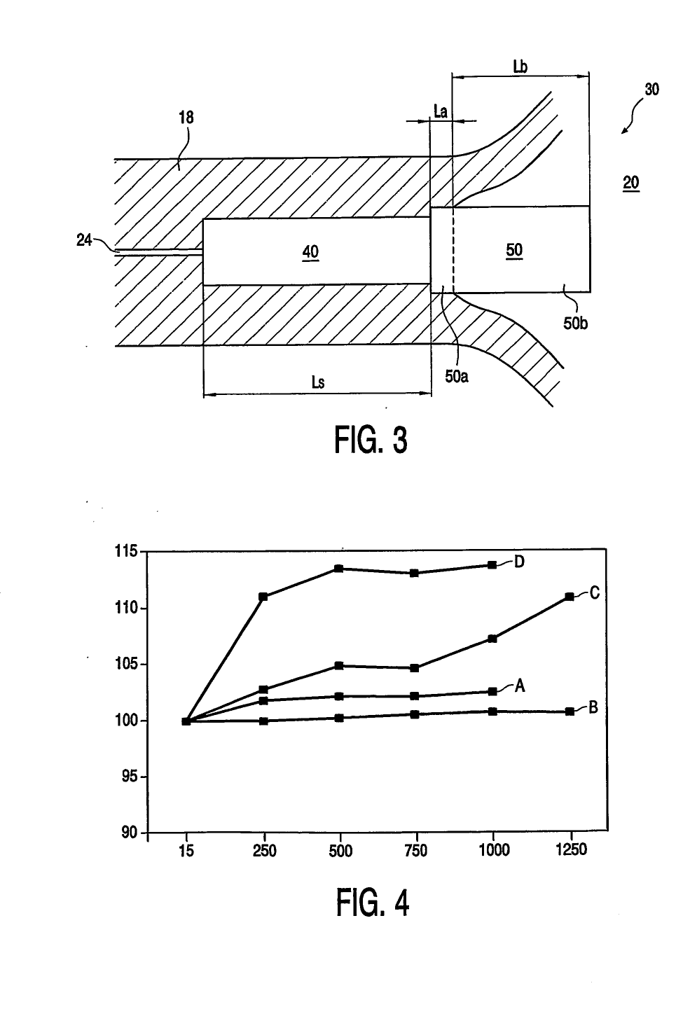

FIG. 3 is a cross-sectional view of an electrode which is partly embedded in the discharge vessel wall of the burner of FIG. 1;

FIG. 4 is a diagram showing the electrode spacing over lamp life for various electrodes;

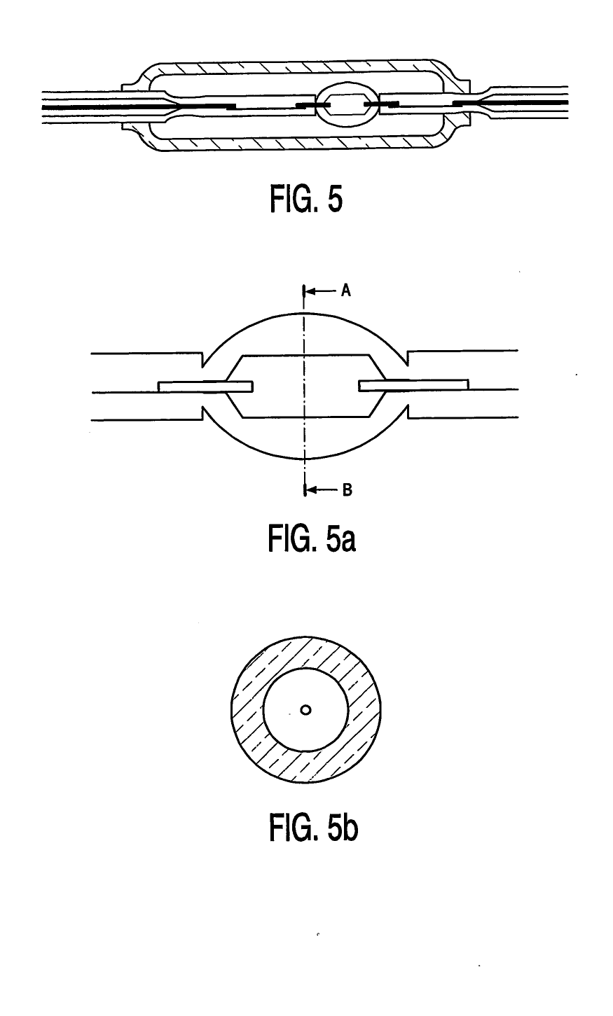

FIG. 5 shows the burner of a second embodiment of the lamp;

FIG. 5a shows the discharge vessel of the burner of FIG. 5 on an enlarged scale; and

FIG. 5b is a cross-sectional view taken on the line A-B in FIG. 5a.

FIG. 1 is a general view of a discharge lamp 10 designed for use as a motor vehicle lamp, with a lamp cap 12 in which a burner 14 is supported.

The burner 14 is shown in FIG. 2. An elongate glass body 18 is arranged in an outer bulb 16 and forms a closed discharge vessel 20 in its central portion, elliptically shaped in longitudinal section and having lateral neck regions 22. The neck regions of the body 18 are formed by locally pinching together of the body which was initially formed as a glass tube. These regions are accordingly denoted “pinches”. Electrodes 30 project into the interior of the discharge vessel and are embedded with their rear portions in the respective neck regions 22 of the body 18. The electrodes 30 are connected to molybdenum strips 24 which are also embedded in the interior of the body 18 and which in their turn are electrically connected to external contacts 26. The molybdenum foils 24 form sealing regions in the neck regions 22 so as to ensure that the interior of the discharge vessel 20 is as fully sealed off from the surroundings as possible.

The interior of the discharge vessel 20 contains an ionizable filling of a rare gas, for example xenon, and metal halides, for example scandium iodide and/or sodium iodide, which is under pressure at room temperature.

As is known to those skilled in the art, the application of an ignition voltage to the electrodes 30 will generate a gas discharge inside the discharge vessel 20.

FIG. 3 shows one of the electrodes 30 with its embedding in the body 18 on an enlarged scale. The shape and nature of the embedding of the electrode is shown here for only one electrode. The electrode at the opposite end, however, has the same shape and is embedded substantially in the same manner in the body 18, so that the discharge vessel 20 is substantially symmetrical.

As is visible in FIG. 3, the electrode 30 comprises a shaft part 40 and a head part 50. The shaft part 40 and the head part 50 are cylindrical in shape. The shaft part 40 in the present example has a diameter of 300 μm, and the head part 50 has a diameter of 350 μm.

The shaft part 40 consists of a tungsten-rhenium alloy with 74% by weight of tungsten and 26% by weight of rhenium. The head part 50 is made of pure, undoped tungsten (WZG).

The head part 50 and the shaft part 40 are welded together at a contact location. Three laser weld spots are used for this, distributed over the circumference.

The shaft part 40 is fully enclosed in the neck region 22 of the body 18. It is surrounded by quartz material. It merges with its rear end into the molybdenum strip 24, as is shown in FIG. 3. It is in contact with the glass material of the bulb 18 over its entire circumferential surface. The shaft part 40 is not in contact with the interior of the discharge vessel 20.

The head part 50 of the electrode 30 is in contact with the glass material of the body 18 by only a small portion. In FIG. 3, the rear portion adjoining the shaft part of the electrode 30 and in contact with the wall of the discharge vessel 20 over its circumference is denoted the first portion 50a, which is separated from a second, front portion 50b along an imaginary boundary (shown in a broken line in FIG. 3). The portion 50b is substantially longer than the portion 50a, i.e. the head part of the electrode is embedded in the body 18 only by a very small portion.

In FIG. 3, the axial length of the shaft part 40 is denoted Ls, the length of the first portion 50a of the head part 50 is denoted La, and the length of the second portion 50b of the head part 50 is denoted Lb. In the example shown, the length Ls of the shaft part 4 is 4 mm, and the length of the head part is 2 mm, with the first, embedded portion 50a accounting for approximately 0.2 mm thereof.

The radiating surface area of the electrode 30 is calculated as follows
π*head diameter*Lb

The radiating surface area in the example shown is approximately 2 mm².

Experiments have shown that the shaft part 40 has a good adhesion to the surrounding quartz glass because of the shaft material, so that lamp failures caused by radial cracks are substantially avoided.

The lamp in the example shown is made entirely without the use of thorium. Both the electrode material and the filling in the interior of the discharge vessel comprise no thorium oxide.

Various modifications are possible for the embodiment mentioned above. The following recommendations may be made with reference to thermally highly loaded discharge lamps, in particular for automotive applications. These recommendations relate to the electrode material and the electrode geometry, in particular the diameter and length of the head and shaft parts of the electrodes in this case.

Electrode Material

A material with as high as possible a melting point should be used for the electrode head so as to limit burning-off of the electrodes as much as possible. Tungsten was found to be particular suitable in this respect. It should be noted, however, that tungsten has a comparatively good thermal conductivity, which means that only a small portion of the electrode head should be embedded in the wall material so as to avoid an excessive heat transfer and an accompanying strong thermal load.

The determining parameters for the material choice for the shaft part of the electrode are the adhesion between the electrode and the surrounding wall material, usually quart, and the thermal conductivity. The following Table shows a comparison of the adhesions obtaining between the respective electrode materials and a surrounding quartz wall.

| | Adhesion to |
|---|---|
| Electrode material | quartz glass |
| thoriated tungsten (VMT10, 1% | very good adhesion |
| ThO₂ by weight) | |
| undoped tungsten (WZG) | good adhesion |
| tungsten-rhenium alloy | good adhesion |
| (74%/26% by weight) | |
| rhenium | bad adhesion |

The materials having a good adhesion to surrounding quartz glass are preferred for achieving a long lamp life. The “pearl crack” effect with VMT10 embedded in quartz glass and the similar effect with tungsten-rhenium alloy embedded in quartz glass counteracts the formation of glass cracks which propagate to the exterior and thus would lead to lamp failure.

The electrode material has usually comprised thorium in lamps known until now for reducing the cold ignition voltage of the lamp. This also leads to a reduction in electrode temperature. It was found, however, that the absence of thorium oxide in the electrode material, i.e. in the materials proposed here, has a comparatively small influence on the ignition voltage.

The absence of thorium oxide not only in the electrode material but if possible in all the lamp materials, i.e. also in the filling, benefits the lumen maintenance over lamp life. Thorium oxide acts as a crystallization nucleus, with the result that the quartz material of the discharge vessel crystallizes more and more as lamp life progresses, which leads to a worse lumen maintenance. It was found, for example, that the lumen maintenance of lamps operated at high current values (continuous operation approximately 0.7 A, run-up up to 3.5 A) was approximately 97% after 1000 hours of operation of a thorium-free lamp, whereas a comparable lamp with electrode material comprising thorium had no more than approximately 70% of the original luminous flux.

Electrode Dimensions

It was found for electrodes constructed with a head and shaft part of different materials, which head and shaft parts are interconnected by a welded joint, that the strength of the welded joint improves in proportion as the diameters of the head part and the shaft part of the electrode are more equal. It is accordingly preferred that the diameters of the two electrode parts correspond as much as possible.

The electrode diameter of the shaft part should preferably lie at 150 to 400 μm. A fast heating-up of the quartz envelope during switching-on of the lamp (run-up) is made possible thereby, also if a material of low thermal conductivity (see above) is chosen.

A value of between 350 μm and 450 μm is proposed for the diameter of the head part of the electrode, depending on the current, both the run-up current and the operating current. The diameter of the electrode head is to be considered in combination with the free head length (Lb), because the radiating surface area of the electrode is defined by this combination. It was found that an increase in the electrode surface area inside the discharge vessel leads to the radiation of a greater power from the electrode into the discharge vessel. This contributes to the reduction of the thermal load on the neck regions of the discharge vessel.

Effects on Lamp Life, Run-Up Behavior, and Lumen Maintenance

It was found in investigations of the lives of lamps with different electrodes that an electrode design in accordance with the above recommendations yields substantial advantages as regards lamp life. The luminous decrement over lamp life is also smaller with the electrode design as proposed, i.e. lumen maintenance is better.

Tests were carried out to compare various two-part electrodes, whose head and shaft portions are made of different materials, with a coiled electrode (i.e. a rod electrode whose tip is enveloped with coiled wire). Clear advantages were seen for the two-part electrodes with partly embedded heads both as regards the average lamp life and as regards lumen maintenance.

The two-part electrodes also show a clearly reduced burning-back of the electrodes during lamp life. This is shown in FIG. 4. The electrode spacing starting at a lamp life of 15 h, is plotted here for various electrode designs as a function of time. The following electrode designs are compared in FIG. 4, wherein the two-part electrodes each have a head embedded over a length of approximately 0.2 mm in the quartz material.

| | |
|---|---|
| A | two-part electrodes |
| | electrode spacing 3.0 mm |
| | head: WZG 0.4 mm × 2.3 mm |
| | shaft: W/Re 0.4 mm × 4.7 mm |
| B | two-part electrodes |
| | electrode spacing 3.0 mm |
| | head: WZG 0.4 mm × 2.3 mm |
| | shaft: W/Re 0.4 mm × 4.0 mm |
| C | two-part electrodes |
| | electrode spacing 3.0 mm |
| | head: WZG 0.4 mm × 2.3 mm |
| | shaft: WZG 15 mm × 4.7 mm |
| D | rod electrodes with coiling |
| | electrode spacing 3.0 mm |
| | VMT10 0.25 mm × 7 mm |
| | surrounded by coiled WZG 0.08 mm × 2.3 mm |

Qualitatively comparable results were obtained in testing of the same electrodes, but this time in a lamp designed for motor vehicles with an electrode spacing of 3.8 mm.

The run-up behavior is also good with the two-part electrodes. The run-up behavior can be further improved by an increase in the electrode surface area, i.e. an increase in the head diameter. A further factor is the partial embedding of the head part in the wall of the discharge vessel, which leads to a fast heating-up of the wall material and thus to an improved run-up behavior.

FIGS. 5, 5a, and 5b show a second embodiment of a lamp in which the discharge vessel has a different shape. The discharge vessel 20 in this second embodiment is cylindrical in its center and narrows conically at its ends.

The invention may be summarized in that a discharge lamp is proposed with a closed discharge vessel which is surrounded by a wall of transparent material. Two electrodes are present, which are partly embedded in the wall and which project into the interior of the discharge vessel. At least one, but preferably both electrodes are elongate in shape and consist of a head part and a shaft part which are distinguished by different diameters and/or different materials. Tungsten is preferred for the head part and a tungsten-rhenium alloy for the shaft part. The shaft part is enclosed in the wall material, usually quartz, whereas the head part is in contact with the wall by a first, short portion only, while its second, longer portion projects into the interior of the discharge vessel. Favorable diameters for the head part were found to be 350 to 450 μm, and for the shaft part 150 to 400 μm. A long lamp life is achieved with the electrode design according to the invention, in particular in thermally strongly loaded discharge lamps as preferred for automotive applications. In addition, there are advantages in the form of a lesser crystallization of the discharge vessel, a less strong burning-off of the electrodes, and an improved run-up behavior.

1. A discharge lamp comprising
a closed discharge vessel (20) which is surrounded by a wall of transparent material,
and two electrodes (30) which are partly embedded in the wall and project into the interior of the discharge vessel (20),
wherein at least one electrode (30) is elongate in shape and has a head part (50) and a shaft part (40) made of different materials and/or having different diameters,
of which the shaft part (40) is enclosed over its entire length by the material forming the wall,
and the head part (50) consists of a first portion (50a), which is enclosed by the material forming the wall, and a second, remaining portion (50b) which projects into the interior of the discharge vessel (20),
the second portion (50b) being longer than the first portion (50a).

2. A discharge lamp as claimed in claim 1, wherein
the length (La) of the first portion (50a) of the head part (50) accounts for less than 25% of the total length of the head part (50).

3. A discharge lamp as claimed in claim 1, wherein
the length (La) of the first portion (50a) of the head part (50) is less than 0.7 mm.

4. A discharge lamp as claimed in claim 1, wherein
the head part (50) and the shaft part (40) have substantially the same diameter.

5. A discharge lamp as claimed in claim 1, wherein
the diameter of the head part (50) is 350 to 450 μm.

6. A discharge lamp as claimed in claim 1, wherein
the diameter of the shaft part (40) is 150 to 400 μm.

7. A discharge lamp as claimed in claim 1, wherein
the material of the shaft part (40) comprises at least 60 to 85% by weight of tungsten, the remainder being made up by rhenium.

8. A discharge lamp as claimed in any one of claim 1, wherein
the material of the head part (50) comprises at least 90% by weight of tungsten.

9. A discharge lamp as claimed in claim 1, wherein
the electrode material, and preferably also the material of the gas filling, is free from thorium.

10. A discharge lamp as claimed in claim 1, wherein
the length of the head part (50) accounts for 15 to 50% of the total length of the electrode (30).

11. A discharge lamp as claimed in claim 1, wherein
the length of the head part (50) is 1 to 3 mm.

12. A discharge lamp as claimed in claim 1, wherein
the length of the shaft part (40) is 3 to 7 mm.
